(19) United States
(12) Patent Application Publication
(10) Pub. No.: US 2003/0160096 A1
(43) Pub. Date: Aug. 28, 2003

(54) System for managing and tracking tax and production-related information

(75) Inventor: Nobuyoshi Morimoto, Taipei (TW)

Correspondence Address: Robert C. Kowert, Conley, Rose, & Tayon, P.C., P.O. Box 398, Austin, TX, 78767, US

(73) Assignee: Nihon Dot. Com, Co., LTD

(21) Appl. No.: 10/085,638

(22) Filed: Feb. 28, 2002

(51) Int. Cl. G06F 17/00

(52) U.S. Cl. 235/375

(57) ABSTRACT

A system and method for tracking tax and production-related information for a product is disclosed. The product and/or a package housing the product may include a memory device. The memory device may be configured to store production and tax information related to the product. The system may include one or more computers connected by a network and software to track the production and tax related information. A server may be configured to interface with the memory device (e.g., using a wireless link) in order to read data from and write to the memory device. The system may be portable or may be built into a stationary apparatus such as a conveyer belt or an automated assembly line. Production and tax related information may be generated, updated and accessed in real-time by using a network such as the Internet to communicate with the system and/or the memory device.

### BACKGROUND OF THE INVENTION

1. Field of the Invention

The present invention generally relates to the tracking of product information. More particularly, the present invention relates to a system for managing and tracking value-added tax information and production related information.

2. Description of the Related Art

Use of the latest technologies such as bar codes, cellular telephones and global positioning systems has made it possible to track a product as it is being transported anywhere in the world. Several commercial package-handling companies provide an Internet-based tracking mechanism to track the progress of a product being shipped from a source to a destination. For example, a sender may request the services of a commercial package-handling company to send a package from a particular source to a particular destination. In response, the receiving agent may collect the necessary transportation charges and affix a unique tracking number to the package. The unique tracking number may be in the form of a bar code label. The receiving agent may then scan the unique tracking number of the package and thereby associate it with an incoming date and time stamp before it is entered into the computer system. As the package moves through various intermediary points in the shipping process, it may be scanned, and the intermediary point agent may update the computer database. A sender or a receiver desiring a real-time status update of the progress of the package may access the commercial package-handling company's Internet site and provide the unique tracking number. Upon delivery of the package to the destination, the commercial package-handling company's delivery agent may then capture an electronic signature of the receiving party and send a confirmation to the sending party.

One such tracking system was disclosed in U.S. patent application Ser. No. 09/675,264, entitled “System And Method For Tracking And Routing Shipped Items”; filed Sep. 28, 2000, which is hereby incorporated by reference in its entirety. However, it would be useful if such a system were expanded to not only benefit those in the shipping business but also in the business of production and manufacturing. One area in particular in which manufacturers need information management assistance is tracking value-added tax and production related information.

Value added tax (VAT) is a levy imposed on businesses at all levels of production of a service, good or product. The VAT, which is based on consumption, is used in 130 countries. The VAT is used predominantly in European countries. It is based on the increase in price or value added to the product at each level or stage of production and distribution. For example, a VAT may be assessed when a product is passed from a supplier to a manufacturer, from a wholesaler to a retailer, and from a retailer to a consumer. The total VAT is typically included in the final cost of the item sold. Exports are not typically taxed, but imports generally are taxed.

Unlike a retail sales tax, the value added tax is charged and collected at each stage of adding value to a product, not just at the final sale to the consumer as is the case of a sales tax. For example, a chemical product may start from one or more raw materials. The raw materials may be mined in country A and shipped to country B. A value added tax may be collected in country B upon importing the raw materials. During the manufacturing or production phase of the chemical product in country B, one or more of the raw materials may be mixed to form an intermediary chemical. The intermediary chemical may be shipped to country C for producing the final chemical. A value added tax may be collected by country C upon importation. The VAT for country C may be based on the value added as result of transforming the raw materials into an intermediary chemical. The intermediary chemical may undergo further steps in production to produce the final chemical, which may be shipped to a storage facility in country D. A value added tax may be collected by country D once the final chemical is imported, and the VAT may be based on the added value resulting from transforming the intermediary chemical to the final chemical. Country D may also assess additional value added tax when a wholesaler purchases the final chemical product stored in that country.

In some countries, it may be possible for a customer or business to request a refund for VAT paid unnecessarily. Hence, as the product is shipped from one location to another it becomes important to be able to track its value at each stage and in real-time to accurately estimate, collect and/or refund the applicable VAT taxes.

While newer technologies are being developed to track packages in real-time, many businesses, as well as most government agencies, still rely on paper-based technologies and methods to collect taxes. Many commercial package-handling companies use proprietary standards to track packages. Third party agencies, including government agencies, often do not obtain electronic access to the shipment information, including the value of a product. Thus, businesses and government agencies still rely on paper-based declaration forms such as packaging slips, customs declaration forms, etc. to estimate the applicable tax. The use of paper-based information is very inefficient and often inaccurate. The papers are subject to being lost or stolen and the information is very costly to replace. The lack of standards to exchange VAT tax information makes it even more difficult.

Thus, it would be desirable to develop a system for electronically storing and/or retrieving product related information, including product values so that taxes such as VAT may be calculated automatically based on electronic media affixed to the product or to the product's packaging, e.g., an electronic packaging slip.

### SUMMARY OF THE INVENTION

Various embodiments of a system and method for tracking tax and productionrelated information for a product are disclosed herein. In one embodiment, a memory device may be affixed to a product to keep track of the tax and production related information as the product goes through the entire manufacturing cycle. A product may be manufactured by using a manufacturing process. The manufacturing process may include N steps or phases wherein the product value may be increased at the completion of each of the N manufacturing steps. The memory device may be configured to store production and tax information related to the product. Production and tax related information may be generated, updated, and stored in the memory device at the end of each manufacturing step. At the end of the final manufacturing step, an end product with a final product amount value may be produced.

In one embodiment, a tax and production information tracking system may include the memory device, one or more computers connected by a network, and software to track the production and tax related information. In one embodiment, tax and production related information may be accessed by using a communicating device communicatively coupled to the memory device. The communicating device, which may use a computer, may in turn communicate with a network such as the Internet to make the tax and production level information available to other computers and databases. In another embodiment, a server may be configured to interface with the memory device (e.g., using a wireless link) in order to read data from and write to the memory device.

The tax and production information tracking system may be portable or may be built into a stationary apparatus such as a conveyer belt or an automated assembly line. In one embodiment, the production and tax related information may be accessed in real-time by using the communicating device and/or a network such as the Internet to obtain tax and production related information such as the value added tax and the product value.

### BRIEF DESCRIPTION OF THE DRAWINGS

A better understanding of the present invention can be obtained when the following detailed description is considered in conjunction with the following drawings, in which:

FIG. 1 illustrates one embodiment of a system for storing value added tax data;

FIG. 2 is a flow chart illustrating one embodiment of a method for managing tax information for a product;

FIG. 3 illustrates another embodiment of a method for managing tax information for a product;

FIG. 4 illustrates one embodiment of a method for updating a data file;

FIG. 5 illustrates one embodiment of a data file that may be stored in a memory device attached to a product;

FIG. 6 illustrates another embodiment of a method for managing tax and production information for a product;

FIG. 7 illustrates one embodiment of a network usable to implement the systems and methods described herein; and

FIG. 8 illustrates one embodiment of a computer system usable to implement the systems and methods described herein.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

Please note that the headings used herein are for organizational purposes only and are not meant to limit the description or claims. Further note that, as used herein, the terms “package”, “goods”, “product”, and “item” are used interchangeably to refer to an item being shipped. Also note, the word “may” is used in this application in a permissive sense (e.g., meaning having the potential to, being able to), not a mandatory sense (i.e., must).

### DETAILED DESCRIPTION OF EMBODIMENTS

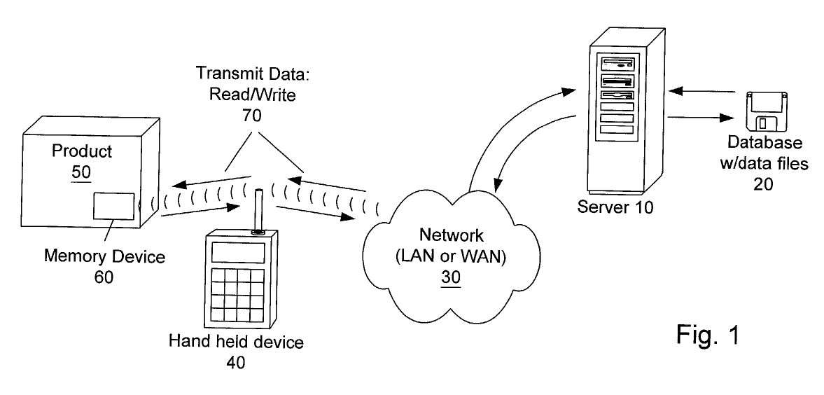

FIG. 1: One Embodiment of a System for Storing Value Added Tax Data

Turning now to FIG. 1, one embodiment of a system for storing value added tax data is shown. In one embodiment, each product 50 that may benefit from storing product related information locally may include an electronic identification device to store the product related data, including tax data. In one embodiment, the electronic identification device, which may be a memory device 60, may be an integral part of the product 50 itself. For example, a memory device 60 may be implanted or formed into an automobile dashboard. Alternatively, a memory device 60 may be affixed to a product such as an appliance by using a bonding agent such as an adhesive or glue. In another embodiment, the electronic identification device may be affixed to a package, box, container, or similar enclosure used to house the product.

In one embodiment, a communications device may be configured to read, write, or store data in the memory device 60. For example, the communications device may include a handheld communications device 40, a scanner, or a computer. The memory device 60 and the communications device 40 may communicate over physical or wireless communications media. In another embodiment, the memory device 60 may communicate directly with a server computer 10. The memory device 60 may be operatively coupled to one or more computers, which may be included in a network 30 of computers designed to track product and tax related information. In one embodiment, the memory device 60 may be configured to synchronize its data with the data stored in a server computer 10 in real-time.

In one embodiment, the data may be stored in the memory device 60 in a variety of formats including as a database file, as a data file, as a table, or as an ASCII text file. The database file may store data relevant to the product, such as the total product value amount and the processing or manufacturing modifications made to the product. During the manufacturing cycle, a product may be produced in stages, often starting with raw materials and ending with the end product, e.g., a final customer deliverable product. Various manufacturing processes may convert raw material(s) to a finished product by adding value in terms of labor and/or materials. Large complex products such as an automobile may be manufactured as sub-assemblies in various parts of the world and may be shipped to an assembly plant for final assembly of the end product. In one embodiment, the memory device 60 may track the entire manufacturing cycle of a product or a sub-assembly starting from the raw materials to the end product. In one embodiment, the memory device 60 may store real-time information about the value created in the product 50 as it moves through the manufacturing cycle. In other words, the memory device 60 may include the real-time value of the product 50 being manufactured as the product moves through various phases such as raw material, subassembly, a first product, or an end product. A second product may be a first product that has been modified, has value added to it, or has been further processed or manufactured. The end product may be a product that has no further value added to it in terms of the manufacturing cycle.

The handheld communications device may be configured to communicate with the memory device 60 to send and receive data 70 relevant to the product 50. In one embodiment, the communication between the two devices may occur in real-time and may occur throughout the manufacturing process. The communications device 40 may be configured to not only read the data stored on the memory device 60, but also to write to the data file. The communications device 40 may also read and write data stored in the memory device 60 to an external and/or internal database 20. The database 20 may be updated when new data is added through the communications device 40. The database 20 may perform calculations based on the data to get a total value amount, a total tax amount, or even export/import the data to/from other application software packages, such as a spreadsheet, which in turn may calculate the tax amount.

Ensuring security of each device storing the tax and production information may be desirable. A number of commercially available security software and hardware tools such as login identifiers, passwords, firewall software, encryption software, badge readers, thumbprint and/or retinal scan may be employed to verify that only authorized users have access to the system.

One Embodiment of a Memory Device for a Package

One embodiment of a memory device 60 for a package is shown. The memory devices may be implemented using a number of different technologies (e.g., Flash memory, SRAM, DRAM, EEPROM, hard drive, removable optical or magnetic media). The memory devices may have a power supply (e.g., a battery, solar panel, or both) connected to it (e.g., in the case of DRAM), or it may rely on the power supply of the processing unit at the shipping location to provide the necessary power to perform reads and writes. The memory devices may also include interface logic (e.g., transceivers and memory controllers) and appropriate connectors (e.g., RS-232 or universal serial bus (USB)) to control the read and write process. In some embodiments, the memory devices may further include a wireless interface (e.g., infrared or radio wave) to allow the contents of the memory devices to read and written to without requiring a physical connection to the device.

In yet another embodiment, barcode stickers may be used as a memory device 60. In this embodiment, the barcode may be printed out on a sticker and subsequently affixed to the package and/or the product. Additional data may be printed out on additional stickers and affixed to the package near the previous sticker. The information may be read by a barcode scanner, which is configured to read all of the barcodes affixed on the package. In one embodiment, the barcode could be interfaced with a solar-powered energy-saving barcode reader to retrieve data about the package. In the event that some of the data needs to be overwritten, additional barcode stickers may be printed out and affixed to the package over the preceding barcode stickers. Advantageously, this may provide an inexpensive read-write memory device 60.

In embodiments that utilize active memory devices (e.g., electronic or magnetic memory as opposed to barcodes, which are a passive memory), additional features such as global positioning and environmental (e.g., temperature, humidity, vibration) sensing may also be implemented as part of the memory devices. For example, the memory device 60 for a particular container may include a microprocessor (or microcontroller) and a temperature sensor. The microprocessor may be configured to periodically sample the temperature readings from the sensor. If the temperature exceeds a predetermined threshold (e.g., too low or too high), then the processor may store an indication of this (e.g., the exact temperature and the time that the event took place) in the memory device 60. Alternatively, the processor may be configured to store all periodic temperature readings in the memory device 60, thereby providing the recipient and the shipping company with a complete log of the temperatures experiences by the package throughout the product transportation process. Similarly, if the product's memory device 60 is outfitted with an environmental sensor, then the processing unit may be configured to read the contents of the memory device 60 to ensure that the product has not experienced any environmental extremes. For example, assuming that there are delicate glass components in the package, and if the environmental sensor detects that a vibration exceeding a predetermined maximum threshold has occurred, then the processing unit may signal an alert to the operator. The operator may then notify the shipper and recipient and possibly check the shipped items for damage. Advantageously, if the items have been damaged due to the vibration, the product may be returned to directly to the originating party from an intermediate destination without incurring the additional cost and wasted time of shipping the product all the way to the final destination before finding out that the items inside have been damaged.

Once the package has been inspected for damage, any damage or problems may be noted and appended to the data file. As noted above, the data file may be stored to the memory device 60 and also conveyed to a communicating device and/or a server 10. In addition to the damage, the package weight may be compared with the memory device's weight information stored in the data file. While the use of weight may be optional, it may be particularly advantageous in international shipping where concerns such as smuggling and tax evasion often arise. By insuring that the weight of the package as received is the same as the weight of the package as shipped, customs officials may be less concerned with additional items being smuggled in or out of the package and thus less likely to open the package and thereby delay shipment. Additional information to assist in the customs process may also be read from the data file. For example, a declaration of the type of goods, e.g., a customs declaration for products may be read from the memory device 60.

Embodiments that utilize active memory devices may also include a built-in wireless connection to a server 10. Taking the wireless connection one step further, the memory device 60 may be configured with a long-range wireless communications device 40 (e.g., with a cellular or PCS telephone link, satellite link, or other wireless network protocol) to allow the memory device 60 to periodically upload product information such as the temperature information and other data in the data file to a server 10. Other possibilities include an optional GPS (global positioning system) sensor that can store position information for the container. Currently, the cost of long-range wireless communications and GPS sensors may be prohibitive, but in future these may become more economical options. The memory device 60 may also store digital images of the items being shipped (e.g., as the items are being packed to prove that the items are in good condition before shipment).

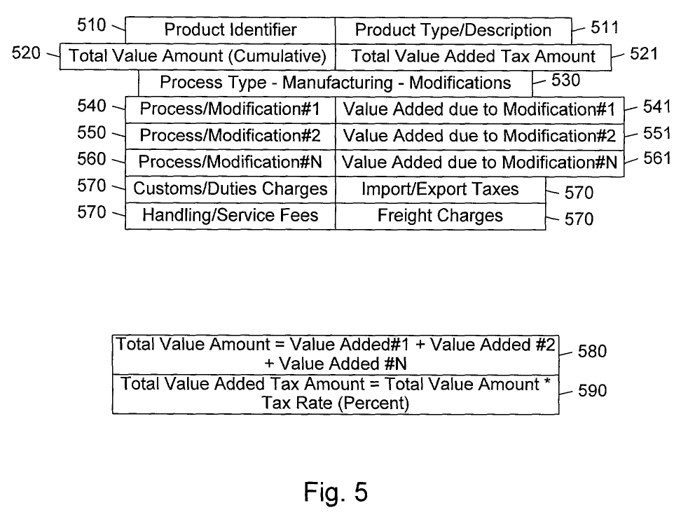

Advantageously, a server 10 may be configured to maintain a real time or near real time database of the production and tax status of all products or goods being produced and shipped using the network. For example, a customer or shipping company may enter in a unique identifier that identifies the goods being shipped at a website, and the tax and production information tracking system may respond by outputting the data file (e.g., as shown in FIG. 5). In one embodiment, each transaction with the memory device 60 may also be stored on the server. Confirmations, alerts, etc. associated with the shipment may be sent to associated parties via e-mail, pager, etc.

Additional Embodiments

In some embodiments the memory device 60 need not be physically attached to the product 50 or package. For example, the memory device 60 may be implemented as a small electronic component (e.g., encased in plastic) designed to be packed inside the packaging for the product. In some embodiments, memory device 60 may be configured as a “stamp” or a “sticker” that may be affixable directly onto the product or the package. In one embodiment, memory device 60 may be able to store information about the product being shipped (e.g., destination information and tax information as described above) without the need for packing the product in a bigger box. This embodiment may be particularly useful for products that are packaged adequately (e.g., in envelopes, boxes or shipping tubes) and that do not need the added protection. Thus, memory device 60 may also form the basis of an automated shipping system. In this embodiment, memory device 60 may be affixed to “third-party” packages (e.g., as part of an internal supply chain used by a manufacturer or retailer for inventory control).

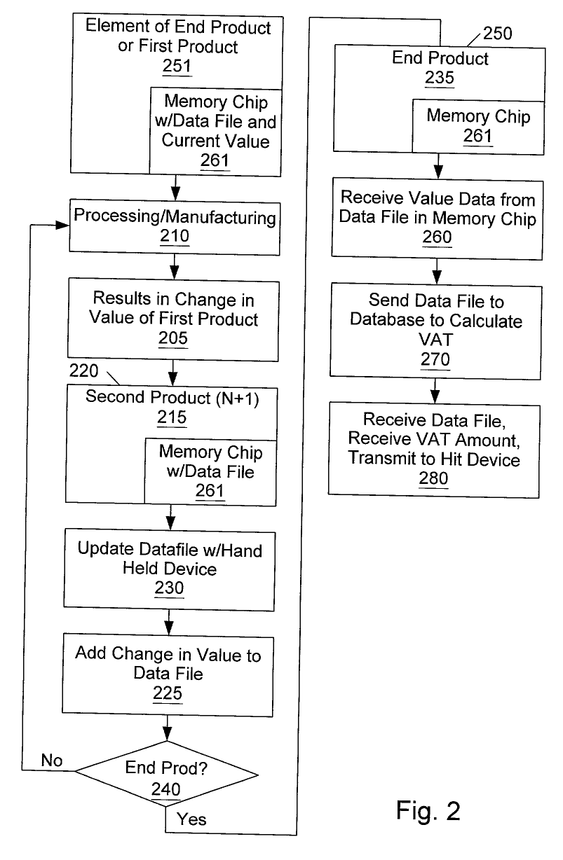

FIG. 2: One Embodiment of a Method for Tracking Value Added Tax

Turning now to FIG. 2, one embodiment of a method for tracking value added tax is shown. In this embodiment, a first product 251 has a memory device 60 affixed to it that may contain data relevant to the value of the product, e.g., a first value 261. Thus, at the point of entry into the manufacturing cycle 200, the memory device 60 associated with the first product may include the first value. The first product may be further processed or manufactured 210 to become a second product 220, thereby raising the value of the product as a whole 205. On completion of the manufacturing phase or cycle, the first product is transformed into a second product 215. The second product holds a value higher than the first product. The second product may also be described as an intermediary or a transitional product.

The incremental value added to the first product in forming the second product may be computed by subtracting the value of the first product from the value of the second product 225. In some cases, the memory device 60 associated with the first product 251 may be replaced during the manufacturing cycle by a second memory device 60 associated with the second product 215. The second memory device 60 may include the entire data stored in the original memory device 60 and may add new data. In other implementations, the original memory device 60 is simply updated.

In this embodiment, the second memory device 60 on the second product 215 may then be updated to reflect the added value using a handheld device 40 that communicates with the memory device 60. The data file in the memory device 60 may include current real-time value data for the product. In one embodiment, the memory device 60 may be equipped with sensors to detect the completion 240 of the second product 215 or of a subsequent phase of the product and may update the value of the product internally. The memory device 60 may then communicate with a communication device 40 to synchronize and/or update the value of the product stored within the network. The product may then be further processed or manufactured to finally result in the end product 235.

The memory device 60 associated with the end product 235 may receive an updated data file from the handheld device 40 and store it 260. In one embodiment, the memory device 60 may use sensors to sense the completion of certain manufacturing processes and automatically update the data file and compute a final value. The final value may then be stored in the memory device 60 and communicated to the database 20 and/or network 30 for synchronization 270.

As previously noted, the value associated with the end product, or any intermediate product, may be used to calculate a value added tax. The computed value added tax 280 may also be stored in the memory device 60. The computation of the value added tax may be performed by a microprocessor or computer connected to the system or network. Other examples of devices which may perform the VAT computation function may include the memory device 60, the communicating device or the server.

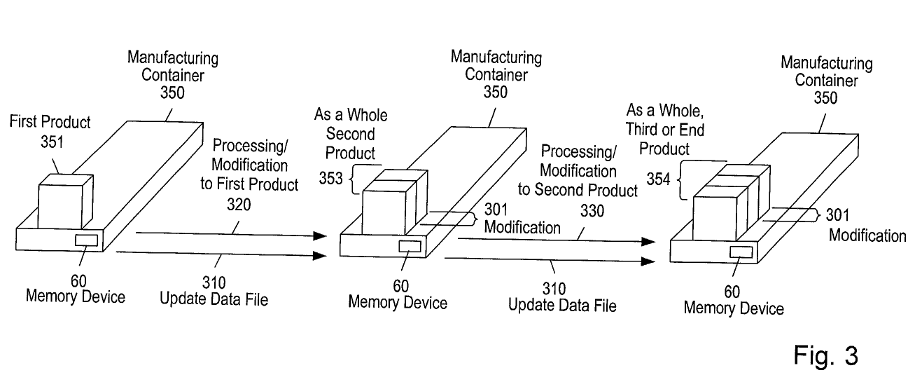

FIG. 3: One Embodiment of a Method for Tracking Value of a Product

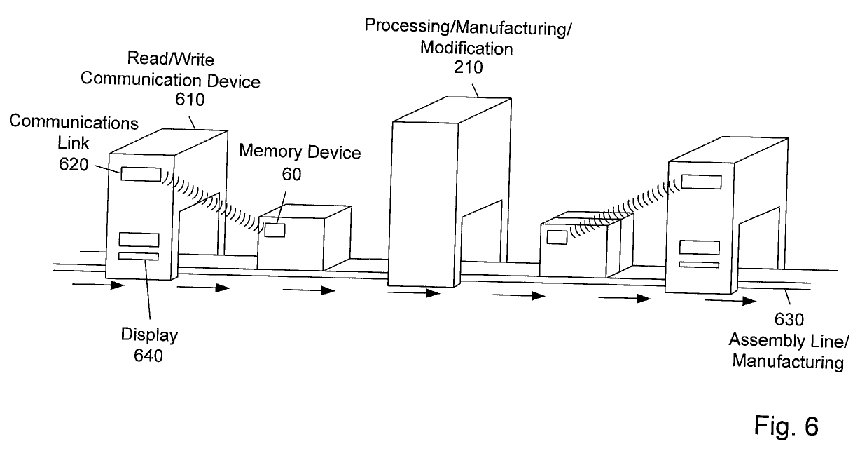

Turning now to FIG. 3, another embodiment of a method for tracking the value of a product is shown. In this embodiment, the first product 351 goes through the manufacturing process 320 in a container 350, and a memory device 60 is affixed to the container 350 holding the product throughout the manufacturing process 320. The container 350 may be a tray or pallet on which the product may sit throughout manufacturing, for example, on an assembly line. The memory device 60 may store all relevant data pertaining to the manufacture of the product, such as the total value of the product and the value added modifications made to the product. In one embodiment, the memory device 60 may be configured to update product values 310 automatically using input from sensors. In one embodiment, the memory device 60 may periodically receive updated values for use as the product value. The memory device 60 data may be accessed using a communications device 40, such as a handheld device. The communications device 40 may also be placed over or in close proximity to an assembly line, as shown in FIG. 6. The communications device may transmit data to and receive data from the memory device 60 through infrared, radio, or other wireless communication. The communications device may write data to the memory device 60, as well as read any data stored in the device.

This embodiment illustrates a product in a manufacturing container 350 as it is processed to form an end product 354 for sale to a retailer or consumer. After the product is modified 301 during the manufacturing processes 320 and 330, the product as a whole has a higher value. The memory device 60 may then be updated to reflect what, if any, value has been added to the product during manufacturing. The communications device 40 may be utilized to write new value data to a data file stored on the memory device 60. The communications device 40 may also write data to a database 20 over a network 30, and the database 20 may store data files for many different products. The database may also be configured to calculate the total value added tax assessed on a product based on the total value amount added to the product through multiple manufacturing steps.

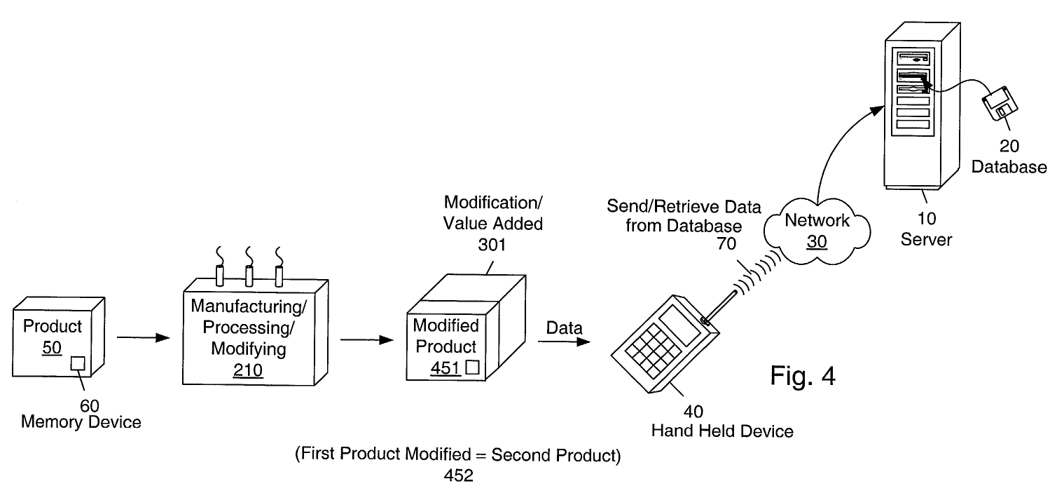

FIG. 4: One Embodiment of a Method for Updating a Data File

Turning now to FIG. 4, one embodiment of a method for updating a data file is illustrated. As shown in the figure, a memory device 60 is affixed to a product 50. The product 50 is then modified in one step of a manufacturing process 210. For example, the product may be a vehicle engine, and the manufacturing process 210 may include installing the engine into a vehicle body. The end result is an unfinished vehicle 451, early in the manufacturing process, but the product as a whole has a higher value than before processing. This value added to the product 301 is written into the data file stored on the memory device 60 using a communications device 40 as an interface. After the value is determined, this amount may be transmitted to the memory device 60 through infrared, radio, or other types of wireless communication. This data may also be transmitted to a database 20 containing data files for multiple products. The communications device 40 may access the database over a network 30, such as a local area network or wide area network. The database 20 calculates any new values and then stores a cumulative total value amount for each product according to an assigned product identifier. After calculation the new data may be transmitted and stored in the memory device 60 using the communications device 40.

In another embodiment, the memory device 60 may use sensors to determine the completion of the current manufacturing phase and to compute a product value based on the value added activities performed during the manufacturing process. The computed product value may be communicated to and synchronized with databases throughout the network 30.

FIG. 5: One Embodiment of a Data File

Turning now to FIG. 5, one embodiment of a data file stored in a memory device 60 is shown. In one embodiment, the data file may include one or more fields describing the product. Each of the one or more fields may contain alphanumeric information to describe an attribute or property of the product. In this embodiment, the data file includes the following:

a) A unique product identifier 510 or a serial number to uniquely identify each product For example, each vehicle sold in the U.S. has a vehicle identification number (VIN) number which uniquely identifies the vehicle.

b) A product type 511 or description—This field may briefly describe the product (e.g., a vehicle manufacturer and model number).

c) A process type 530 or manufacturing identifier—The entire manufacturing cycle to produce a product may be identified by a unique identifier. For example, the process to make a chemical X may be identified by ‘process_batch’.

d) Number of intermediary steps—The manufacturing cycle may include one or more intermediary steps. The intermediary steps may include steps 1 through N.

e) Intermediary step identifier/descriptor (540 through 560)—Each step of the N steps may be described by a unique identifier and/or a descriptor. For example, a first step, process or modification may include installing a car engine into a car frame. A second step or process may include installing doors onto the car frame. An Nth step may include a test drive for the assembled vehicle.

f) A product value at an intermediary step 1 through N (541 through 561)—Each step of the N steps may add a distinct incremental value to the overall product value. For example, if the product value before executing step 1 was PV1 and the product value at the beginning of step 2 was PV2 a value added during first step is calculated as PV2-PV1.

g) A total value amount (cumulative) 520—This field may provide a current or real-time cumulative value for the product. The total value amount equals the sum of the values added from the first step through the Nth step 580. In other words, the total value amount is a cumulative total of any value amounts added to the product during the entire manufacturing or processing cycle.

h) A tax amount 521—The tax amount, such as the VAT tax, may be calculated as a percentage of the total value amount 590.

The data file may also include other variables 570, such as: customs or duties charges, import or export taxes, handling or service fees, or freight charges. In this embodiment of a data file, the total value amount equals the value added after the first process, the value added after the second process, and the value added after the N process. In other words, the total value amount is a cumulative total of any value amounts added to the product during processing. In one embodiment, the VAT may be computed as a percentage of the total amount value.

Another Embodiment of a Data File

In one embodiment of the data file stored in memory device 60, the data file may be further expanded to include additional information pertaining to the product. In this embodiment, the data file may include packaging slip information such as, but not limited to:

a) a unique item identification number (e.g., a package tracking number)

b) a description of the goods being shipped

c) the weight of the goods being shipped

d) any special shipping instructions (e.g., temperature, humidity, and vibration restrictions)

e) insurance terms (e.g., the insurance carrier, the policy number, the amount of insurance, and any deductible amounts)

f) the original shipping date

g) the arrival deadline

h) the point of origination

i) the destination point

j) payment terms

k) information about the sender (e.g., sender's name, sender's email address, sender's telephone number, sender's street address, sender's shipping company account number)

l) information about the recipient (e.g., recipient's name, recipient's email address, recipient's telephone number, recipient's street address, recipient's shipping company account number), and

m) information about one or more intermediate destinations.

In some embodiments, memory device 60 may be used to simplify the payment process (e.g., for shipping, taxes, tariffs or customs charges, or for the goods themselves). For example, memory device 60 may include account numbers for the sender and recipient. Other possibilities include credit card, debit card, and bank account information.

FIG. 6: One Embodiment of a System and a Method for Tracking Data in a Memory Device on a Product

FIG. 6 also illustrates one embodiment of a system for tracking tax and production related information. In this embodiment, the system includes a conveyor belt 630. As shown in the figure, conveyor belt 630 is configured to convey product 50 from a starting point to another point within the manufacturing cycle. The system may further include a communications device 610 configured to communicate with and read the contents of memory device 60.

In some embodiments, the system may further include one or more sensors such as digital cameras (not shown). As previously noted, these digital cameras may be configured to capture images of the product 50. In some embodiments (assuming there is enough storage available in the memory device 60), these images may be stored in the memory device 60 by the package-processing unit using communications device 610. Note, this figure merely illustrates one possible embodiment for the system and other embodiments are possible and contemplated. For example, in one embodiment the apparatus may be implemented as a handheld device without conveyor belt 630. The handheld device may include communications device 610 to communicate with memory device 60, and one or more sensors such as a digital camera configured to capture images of the product 50. Other embodiments may be configured without sensors such as the digital camera. Communications device 610 may be wireless link 620, a physical cable that connects to memory device 60, or a removable media reader (e.g., a CD-RW drive).

Advantageously, the system for tracking tax and production related information described above may be installed at several locations such as airports and shipping ports, customs facilities, receiving departments, warehouses, distribution centers, and shipping companies. The operation of the system may be automated, to automatically read and write data to the memory device 60. The system may further comprise an interface to a computer system. Computer system may in turn be connected to a network 30 (e.g., the Internet). The computer system may control the memory device 60 and convey the captured data (e.g., from memory device 60 and digital cameras to a server 10. As noted above, in other embodiments the system may include a communication device 40 with an internal computer or microprocessor with a built-in wireless connection to a network 30 and to the memory device 60.

By accessing the data files stored in server 10's database 20 (e.g., by using an Internet website) and/or by using any communicating device, any authorized party may be able to immediately gain access to product value and tax related information. As previously noted, additional information may also be available (e.g., any damage that the device may have sustained or any environmental extreme the container may have experienced).

In some implementations, the server 10 may be configured to routinely poll each communicating device and/or memory devices to determine product value, production status, VAT taxes, etc. Server 10 may be configured to maintain a database 20 of this information that is periodically updated. A customer and/or a government agent wishing to access the product value information about a particular product may contact one of the regional shipping companies or the server directly (e.g., via the Internet). The customer and/or a government agent may be prompted to provide information about the package (e.g., tracking label identification number, origination point, final destination, shipping deadline, etc.). After verifying the credentials of the customer and/or government agent, the tax and production information tracking system server 10 may query the database and/or the memory device 60 to provide information about the VAT, product value, etc. Additionally, the system server may provide additional VAT related information in an electronic form over the Internet.

In some embodiments, the server 10 may be configured to automatically notify one or more users of the tax and production information tracking system upon the occurrence of predetermined events. For example, once the product reaches a particular intermediate destination or the final destination, the server upon receiving confirmation of this may be configured to automatically contact the designated recipient (e.g., by an automated call to a telephone or cell phone number, or by e-mail, paging, or instant messaging). Similarly, customs agents may be notified automatically as soon as the package arrives at a particular intermediate or final destination.

In some embodiments, the unique identification number associated with a particular product may be assigned by server 10. In other embodiments, the local shipping company may assign this number after verifying that there is no other package currently using the number in server 10's database 20. In some embodiments, the unique ID number may be shared with one or more transportation companies that handle the package from its origination to its final destination. For example, assuming a package is shipped by airlines A and then delivered by trucking company B, airline A and trucking company B may both be provided access server 10 to read the data file. The unique identification number may be selected in a format such that it is useable both by airline A's and trucking company B's computer systems. In one embodiment, server 10 may be configured to contact the servers of airline A and trucking company B in order to select a unique identifier that is also useable by those companies' computer systems. Advantageously, this unique identifier may also be used to control billing receipts and customs records for the shipped item.

In one embodiment, server 10 may be implemented as a number of different servers (e.g., one server in each country that is a part of the VAT tracking network). In one embodiment, the data file associated with a particular product may be stored only on the server residing in the originating country. The data file may be formatted using XML, SGML, HTML, or another type of mark-up language or data file format. XML offers several potential advantages including the ability to format data such that it may be more easily imported into a SQL database.

Returning to FIG. 6, a product goes through a manufacturing process, a memory device 60 may be affixed to a manufacturing container in which the product is held. The container may be a box, tray or pallet on which a product may sit through manufacturing, for example, on an assembly line 630. The memory device 60 may store all relevant data pertaining to the manufacture of the product, such as the total value of the product and the value added modifications 210 made to the product.

In one embodiment, a product may be placed at the beginning of the assembly line or the manufacturing process. The manufacturing process may include N value added phases. The product at the beginning of the assembly line may be identified as a first product. The product at the beginning of the second phase may be identified as a second product and the product at the end of the Nth or the last phase may be identified as the end or final product. In one embodiment, the memory device 60 may receive updated data from the communications device 610, which may be placed over or in close proximity to an assembly line, as shown in the figure. In one embodiment, a communications device may be placed at the end of each phase of the assembly process. As the product moves through the assembly line, the communicating device may update the memory device 60 at the end of each phase and store information indicative of the processing performed on the product. The updating of data in the memory device 60 may be repeated at the end of all N phases.

In one embodiment, the memory device 60 may update product data automatically using inputs from sensors. In one embodiment, the communications device may transmit and receive data to the memory device 60 through infrared, laser, radio, optical, or other communication media. The communications device may write data to the memory device 60, as well as read any data stored in the device. The memory device may also be coupled to sensors (e.g., temperature sensors, humidity sensors, light sensors, and noise sensors).

In some embodiments, the memory device may become part of the product in the manufacturing process. Then, the memory device may be configured to track how the goods are used and handled. The memory device may also monitor the preferences of users. The information stored in the memory device (e.g., during the manufacturing process) may be used to verify the product's origin (e.g., by unique serial number). This information may be used in providing warranty service if any claims arise.

This embodiment illustrates a product in a manufacturing container as it is processed to result in an end product for sale to a retailer or consumer. After the product is modified during the manufacturing process, the product as a whole has a higher value. The communications device may also write data corresponding to the higher value to a database over a network. The database 20 may store data files for many different products. The database 20 may also be configured to calculate the total value added tax assessed on a product based on the total value amount.

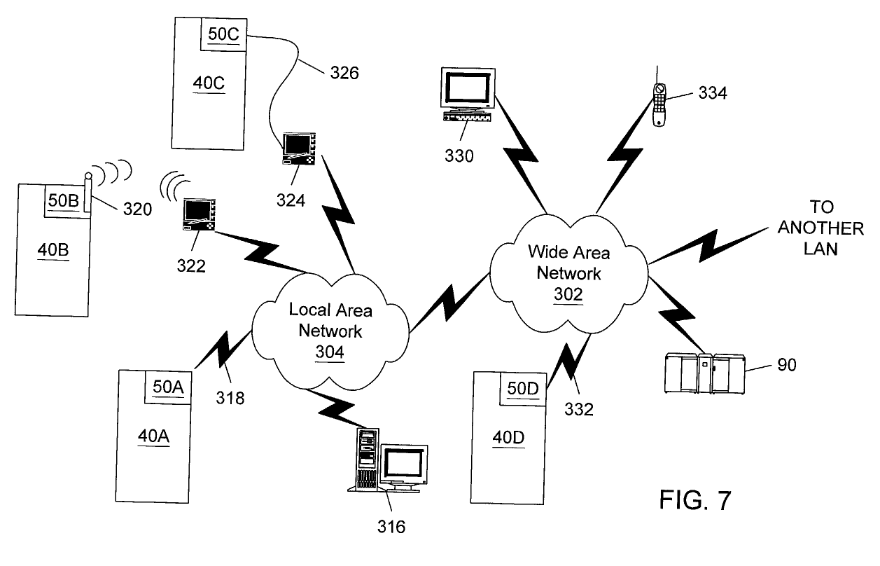

FIG. 7: Wide Area Network

Turning now to FIG. 7, one embodiment of a wide area network (WAN) that may be used to implement the system described above is shown. WAN 302 is a network that spans a relatively large geographical area. The Internet is an example of WAN 302. WAN 302 typically includes a plurality of computer systems which are interconnected through one or more networks. Although one particular configuration is shown in the figure, WAN 302 may include a variety of heterogeneous computer systems and networks which are interconnected in a variety of ways and which run a variety of software applications.

One or more local area networks (LANs) 304 may be coupled to WAN 302. A LAN 304 is a network that spans a relatively small area. Typically, a LAN 304 is confined to a single building or group of buildings (e.g., one airport or shipping hub). Each node (i.e., individual computer system or device) on a LAN 304 preferably has its own CPU with which it executes programs. LAN 304 allows many users to share devices (e.g., printers) as well as data stored on file servers. The LAN 304 may be characterized by any of a variety of types of topology (i.e., the geometric arrangement of devices on the network), of protocols (i.e., the rules and encoding specifications for sending data, and whether the network uses a peer-to-peer or client/server architecture), and of media (e.g., twisted-pair wire, coaxial cables, fiber optic cables, radio waves). In one embodiment, a LAN 304 and/or a WAN 302 may represent a network 30.

Each LAN 304 includes a plurality of interconnected computer systems and optionally one or more other devices: for example, one or more personal computers 316 and one or more systems for tracking tax and production information 318-324. Systems 318-324 may, for example, be hand-held devices 40 or conveyor-belt devices 610 as previously described. As illustrated in the figure, some systems (e.g., communicating device 322) may be configured to communicate with memory device (e.g., 50B) affixed to a product (e.g., 40B) via a wireless link 320. In other embodiments, a product 40C may include a memory device 40C that communicates with a system 324 over a wired connection 326. As also noted above, in some embodiments, some configurations of products 40A may have a memory device 50A that is configured to communicate directly with LAN 304 and/or WAN 302. For example, LAN 304 may be constructed at a shipping hub (e.g., an airport, dock or warehouse) and may be configured to use a wireless access protocol that supports the dynamic addition and remove of devices (e.g., using Sun Microsystems, Inc.'s Jini® protocol). Whenever a product is brought within range of the wireless LAN, then the products' memory devices may access the network 30 and communicate their data.

Server 10 may be coupled to multiple LANs via WAN 302. As described above, server 10 may be configured to convey email verification messages to one or more computers (e.g., personal computers 316 and 330) connected to WAN 302 or LAN 304. Server 10 may also be configured to send text of voice messages (e.g., pages) to cell phones (e.g., cell phone 334). WAN 302 may also be configured to communicate with one or more mainframe computers 90.

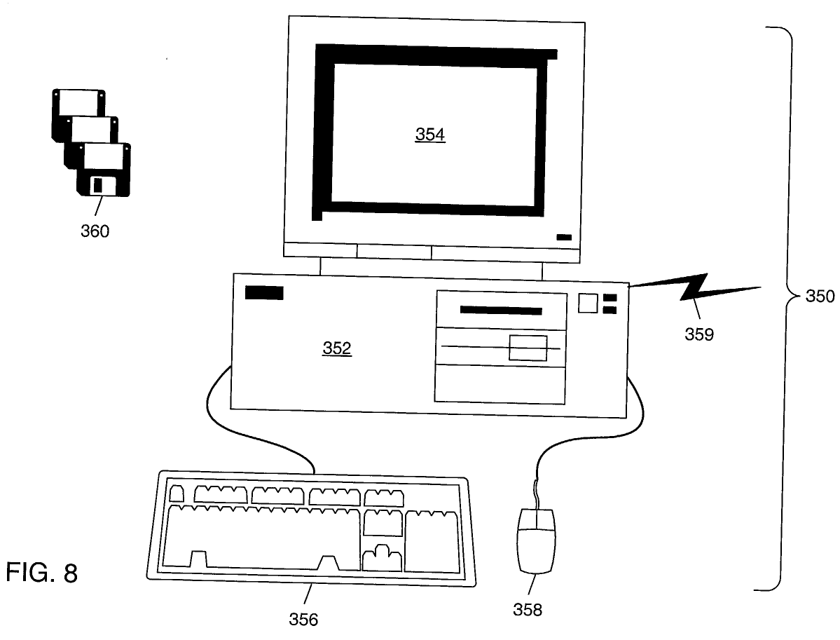

FIG. 8: Typical Computer System

FIG. 8 illustrates a typical computer system 350, which is suitable for implementing various embodiments of the systems and methods described above. Each computer system 350 typically includes components such as a CPU 352 with an associated memory medium such as floppy disks 360, CD-ROMs, or DVDs (not shown). The memory medium may store program instructions for computer programs, wherein the program instructions are executable by the CPU 352. The computer system 350 may further include a display device such as a monitor 354, an alphanumeric input device such as a keyboard 356, communication device such as a modem 359 and a directional input device such as a mouse 358.

In one embodiment, the computer system 350 may be configured to execute a computer program to keep track of tax and production information related to a product. The computer program may include sub-programs for example to access containers' memory devices using one or more interfaces as described herein. In another embodiment, the computer system 350 may be a server (e.g., such as server 10) operable to execute a computer programs to create and manage the database of the memory device 60 information as described herein. Other embodiments of the computer system 350 are also possible and contemplated.

The computer system 350 preferably includes a memory medium on which computer programs according to various embodiments may be stored. The term “memory medium” is intended to include an installation medium, e.g., a CD-ROM, or floppy disks 360, a computer system memory such as DRAM, SRAM, EDO RAM, Rambus RAM, or a non-volatile memory such as a magnetic media, e.g., a hard drive, or optical storage. The memory medium may include other types of memory as well, or combinations thereof. In addition, the memory medium may be located in a first computer in which the programs are executed, or may be located in a second different computer, which connects to the first computer over a network. In the latter instance, the second computer provides the program instructions to the first computer for execution. The computer system 350 may also include a time keeping device such as a real-time clock. The real-time clock of the computer system 350 may be, periodically or on demand, synchronized with a global standard time clock. Also, the computer system 350 may take various forms, including but not limited to a personal computer system, mainframe computer system, workstation, network appliance, Internet appliance, personal digital assistant (PDA), Internet enabled cellular telephones, or any other similar device. In general, the term “computer system” can be broadly defined to encompass any device having a processor, which executes instructions from a memory medium.

The computer system's memory medium preferably stores a software program or programs for performing the methods for efficient shipping as described herein. The software program(s) may be implemented in any of various ways, including procedurebased techniques, component-based techniques, and/or object-oriented techniques, among others. For example, the software program may be implemented using ActiveX controls, programming languages such as C++, Java, Visual Basic, object oriented software based on COM/DCOM and/or CORBA objects, JavaBeans, Microsoft Foundation Classes (MFC), browser-based applications (e.g., Java applets, XML), traditional programs, or other technologies or methodologies, as desired.

Although the embodiments above have been described in considerable detail, other versions are possible. Numerous variations and modifications will become apparent to those skilled in the art once the above disclosure is fully appreciated. It is intended that the following claims be interpreted to embrace all such variations and modifications.

What is claimed is:

1. A method for managing tax information for a product, the method comprising:
receiving a first item;
affixing a memory device to the first item;
storing a data file in the memory device, wherein the data file includes a product identifier;
processing the first item to form a second item, wherein value is added in the formation of the second item;
updating the data file in the memory device with information indicative of the value added to form the second item; and
using the data file to determine a total value added tax for the second item.

2. The method of claim 1, wherein said using the data file comprises:
transmitting the data file to a database; and
calculating a total value added tax for the second product by applying mathematical formulas to the database.

3. The method of claim 1, wherein the information indicative of the value added is an amount of value added tax applicable to the value added to from the second item.

4. The method of claim 1, further comprising automatically transmitting the data file to a tax authority server.

5. The method of claim 1, wherein said processing comprises one or more of the following: refining, machining, assembling, chemically reacting, and welding.

6. The method of claim 1, wherein the data file also includes a product identifier.

7. The method of claim 1, wherein the data file also includes an indicator of an applicable value added tax rate.

8. The method of claim 1, wherein the data file also includes one or more of the following: quality control information, production date information, and expiration date information.

9. The method of claim 1, wherein said updating the data file comprises summing a current value added amount with any previously value added amounts to generate a total value added amount for the second item.

10. The method of claim 1, wherein said updating the data file comprises adding data indicative of said processing.

11. The method of claim 1, wherein said memory device is configured with a wireless interface and a power supply.

12. The method of claim 1, wherein said power supply is a solar cell or battery.

13. The method of claim 1, wherein said memory device is a flash memory device.

14. The method of claim 1, wherein said updating comprises:
reading a product identifier from the data file in the memory device;
accessing a database of value amounts;
selecting an amount of value added based on the product identifier and said processing;
summing the amount with any previous value added amounts in the data file in the memory; and
storing the sum in the memory device.

15. The method of claim 1, wherein said updating is performed automatically using computers and wireless communications links.

16. A method for tracking value added tax, the method comprising:
receiving a first item, wherein the first item has a memory device affixed to it, wherein the memory device stores value added tax information corresponding to the first item;
processing the first item to form a second item;
updating the value added tax information stored in the memory device to reflect an amount of value added to form the second item; and
using the value added tax information stored in the memory device to determine a final amount of value added tax applicable to the second item.

17. The method of claim 16, wherein the value added tax information includes value amounts for each process step performed on the item, and wherein said using comprises applying a value added tax table to the value amounts.

18. A method for tracking value added tax, the method comprising:
receiving an item;
placing the item in a container, wherein the container has a memory device;
storing information about the item into the memory device;
processing the item;
storing information indicative of the processing performed on the item into the memory device;
repeating said processing and said storing information indicative of the processing one or more times;
reading the stored information from the memory device; and
using the information read from the memory device to determine pricing information for the item.

19. The method of claim 18, wherein the pricing information includes value added tax information.

20. The method of claim 18, wherein the information indicative of the processing performed on the item includes an amount indicative of the value added to the item as a result of the processing.

21. The method of claim 18, wherein said storing information about the item, said storing information indicative of the processing, and said reading the stored information are performed by a hand-held wireless communications device.

22. The method of claim 18, wherein said storing information about the item, said storing information indicative of the processing, and said reading the stored information are performed by a plurality of wireless communications devices positioned throughout a manufacturing or assembly line.

23. The method of claim 22, wherein the plurality of wireless communications devices are configured to communicate with a central computer configured to manage the wireless communications devices and to transmit data to and from the wireless communications devices.

24. The method of claim 18, wherein the memory device is a flash memory.

25. The method of claim 18, wherein the memory device includes a power supply and a wireless communications interface.

26. The method of claim 18, further comprising transmitting an item identifier and the information indicative of the processing from the memory device over a network to a data file in a database and updating the data file in the database.

27. The method of claim 18, wherein the item identifier and the information indicative of the processing are encrypted during said transmitting.

28. The method of claim 18, wherein the network comprises one or more of the following: a local area network (LAN) and a wide area network (WAN).

29. An electronic medium storing a computer software program for tracking value added tax for an item, wherein the program is configured to:
assign an item identifier to the item;
store the item identifier to a memory device affixed to the item;
receive input identifying the progress of the item through a production or manufacturing process;
determine a value added to the item in the production or manufacturing process; and
store information indicative of the value added to the item into the memory device.

30. The electronic medium of claim 29, wherein the production or manufacturing process comprises multiple stages, wherein the program is configured to receive input, determine the value added, and store information indicative of the value added for each of the multiple stages.

31. The electronic medium of claim 29, wherein the program is configured to receive input, determine the value added, and store information indicative of the value added in real time.

32. The electronic medium of claim 29, wherein the program is configured to:
read the information from the memory device; and
calculate a value added tax based on the information.

33. The electronic medium of claim 29, wherein the program is configured to:
output the value added tax in a user-specified currency.

34. The electronic medium of claim 29, wherein the program is configured to:
receive input identifying manufacturing or production information for the item; and
store the information into the memory device.

35. An apparatus for storing value added tax data for an item, comprising:
a memory device;
a microprocessor;
an interface coupled to the memory device and the microprocessor, wherein the interface is configured to allow reading and writing of data to the memory device; and
a power supply coupled to the memory device, the microprocessor, and the interface, wherein the memory device is configured to be attached to the item.

36. The apparatus of claim 35, further comprising a container to which the memory device is affixed, wherein the container is configured to hold the item through a production or manufacturing process.

37. The apparatus of claim 35, wherein the interface is a wireless interface.

38. The apparatus of claim 35, wherein the microprocessor is configured to periodically transmit and receive information using the interface.

39. A method for tracking value added tax for a product, the method comprising:
designating a memory device to identify a product being manufactured, wherein the memory device stores data describing the product and wherein the memory device follows the product being manufactured throughout the manufacturing process;
storing first data describing a first product in the memory device;
adding value to the first product to manufacture a second product;
storing second data describing the second product in the memory device;
calculating the value added tax for the second product using the first data and the second data.

40. A method for determining a product value for a product, the method comprising:
designating a memory device to identify a product being manufactured, wherein the memory device stores data describing the product and wherein the memory device follows the product being manufactured throughout the manufacturing process;
storing first data describing a first product in the memory device;
adding value to the first product to manufacture a second product;
storing second data describing the second product in the memory device;
calculating the product value for the second product using the first data and the second data.

41. A system for tracking product value for a product, the system comprising:
a memory device enabled to store and output data;
a microprocessor coupled to the memory device, wherein the microprocessor is configured to read and write data to the memory device; and
a computer program executable by the microprocessor to:
designate the memory device to identify the product being manufactured, wherein the memory device comprises data describing the product and wherein the memory device follows the product being manufactured throughout the manufacturing process;
store first data describing a first product in the memory device;
store second data describing the second product in the memory device in response to value being added to the first product to manufacture a second product;
calculate the product value for the second product using the first data and the second data.

42. A carrier medium that stores program instructions, wherein the program instructions are computer-executable to implement:
designating a memory device to identify a product being manufactured, wherein the memory device comprises data describing the product and wherein the memory device follows the product being manufactured throughout the manufacturing process;
storing a first data describing a first product in the memory device;
storing a second data describing the second product in the memory device in response to value being added to the first product to manufacture a second product;
calculating the product value for the second product using the first data and the second data.
